(19) United States
(12) Patent Application Publication
(10) Pub. No.: US 2006/0215824 A1
(43) Pub. Date: Sep. 28, 2006

(54) System and method for handling a voice prompted conversation

(76) Inventors: David Mitby, Mountain View, CA (US); Andrea Klein, Mountain View, CA (US); Matthew O'Connor, San Jose, CA (US); Matthew Marx, West Newton, MA (US); Craig Nicol, San Francisco, CA (US); Jonathan Katzman, San Francisco, CA (US); Firooz Partovi, Hillsborough, CA (US)

Correspondence Address: FAY KAPLUN & MARCIN, LLP, 15O BROADWAY, SUITE 702, NEW YORK, NY, 10038, US

(21) Appl. No.: 11/107,696

(22) Filed: Apr. 15, 2005

Related U.S. Application Data
(60) Provisional application No. 60/665,710, filed on Mar. 28, 2005.

(51) Int. Cl. H04M 11/00

(52) U.S. Cl. 379/100.05

(57) ABSTRACT

Described is a method of handling automated conversations by categorizing a plurality of events which occur during automated conversations based on an impact of the events on a level of user satisfaction with the automated conversations, assigning to each category of events a quality score corresponding to the impact on user satisfaction of the events in each category and initiating a conversation handling action for one of the conversations based on the categories of events detected during the one of the conversations.

### PRIORITY/INCORPORATION BY REFERENCE

The present application claims priority to U.S. Provisional Patent Application No. 60/665,710 entitled “System and Method for Handling a Voice Prompted Conversation” filed on Mar. 28, 2005, the specification of which is expressly incorporated, in its entirety, herein.

### BACKGROUND INFORMATION

The automation of information based phone calls such as directory assistance calls may substantially reduce operator costs for the provider. However, users can become frustrated with automated phone calls reducing customer satisfaction and repeat business.

### SUMMARY OF THE INVENTION

A method of handling automated conversations by categorizing a plurality of events which occur during automated conversations based on an impact of the events on a level of user satisfaction with the automated conversations, assigning to each category of events a quality score corresponding to the impact on user satisfaction of the events in each category and initiating a conversation handling action for one of the conversations based on the categories of events detected during the one of the conversations.

In addition, a system having a storage module storing a categorization of a plurality of events which occur during automated conversations, the categorization being based on an impact of the events on a level of user satisfaction with the automated conversations, wherein each of the events of each category is assigned a quality score corresponding to the impact on user satisfaction of the events in each category and a quality score module initiating a conversation handling action for one of the conversations based on the categories of events detected during the one of the conversations.

A system comprising a memory to store a set of instructions and a processor to execute the set of instructions, the set of instructions being operable to access a categorization of a plurality of events which occur during automated conversations, the categorization being based on an impact of the events on a level of user satisfaction with the automated conversations, access a quality score assigned to each category of events, the quality score corresponding to the impact on user satisfaction of the events in each category and initiate a conversation handling action for one of the conversations based on the categories of events detected during the one of the conversations.

Furthermore, a method that categorizes a plurality of events which occur during automated conversations based on an impact of the events on a level of user satisfaction with the automated conversations, assigns to each category of events a quality score corresponding to the impact on user satisfaction of the events in each category and records user satisfaction for a plurality of automated conversations based on the categorization of events detected during the conversations.

A method for storing a sequence of events which occur during automated conversations. recording events in one of the automated conversations and initiating a conversation handling action for the one of the conversations when the recorded events correspond to the stored sequence of events.

### BRIEF DESCRIPTION OF DRAWINGS

FIG. 1 shows an exemplary network arrangement for the connection of voice communications to a directory assistance service according to the present invention.

FIG. 2 shows an exemplary automated call to a directory assistance service.

FIG. 3 shows a second exemplary automated call to a directory assistance service.

FIG. 4 shows a table including exemplary negative events of an automated conversation and an exemplary quality score impact of each of these events according to the present invention.

FIG. 5 illustrates an exemplary method for handling a conversation using the determined quality score according to the present invention.

FIG. 6 shows a table categorizing calls based on the quality score of the call according to the present invention.

FIG. 7 shows a graph with exemplary results for various quality score threshold values according to the present invention.

FIG. 8 shows an exemplary state diagram for an automated conversation according to the present invention.

### DETAILED DESCRIPTION

The present invention may be further understood with reference to the following description and the appended drawings, wherein like elements are provided with the same reference numerals. The present invention is described with reference to an automated directory assistance phone call. However, those of skill in the art will understand that the present invention may be applied to any type of automated conversation. These automated conversations are not limited to phone calls, but may be carried out on any system which receives voice responses to prompts from the system.

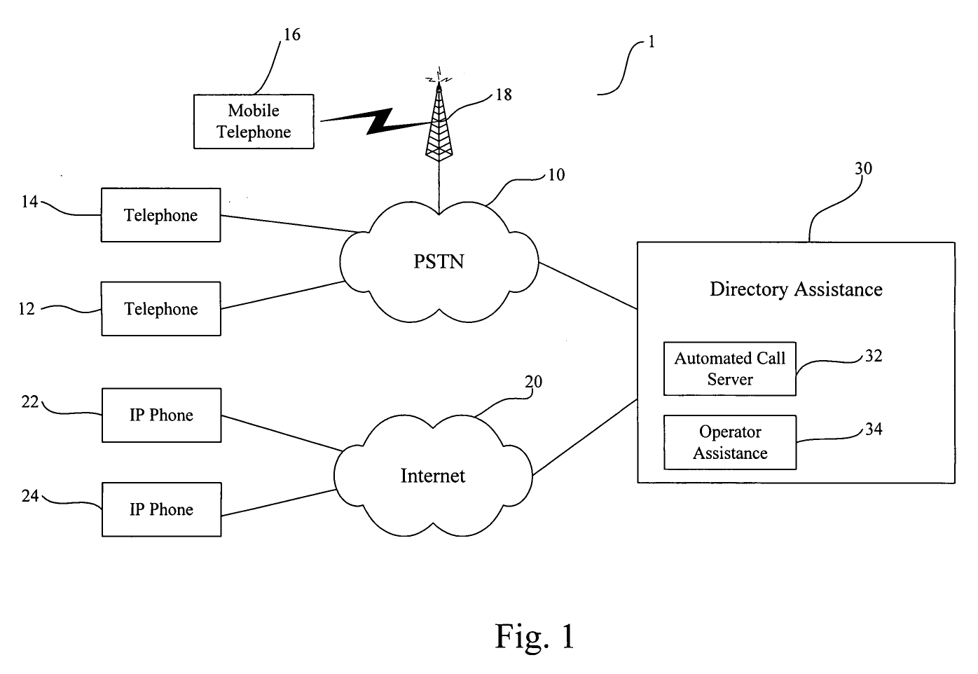

FIG. 1 shows an exemplary network arrangement 1 for the connection of voice communications to a directory assistance service. The network arrangement 1 includes a directory assistance (“DA”) service 30 which has an automated call server 32 and operator assistance 34. The components 32 and 34 of the DA service 30 will be described in greater detail below. The primary function of a DA service 30 is to provide users with listings (e.g., phone numbers, addresses, etc.) of telephone subscribers including both residential and business subscribers. The DA service 30 has a database or a series of databases that include the listing information. These databases may be accessed based on information provided by the user in order to obtain the listing information requested by the user.

Users may be connected to the DA service 30 through a variety of networks such as the Public Switched Telephone Network (“PSTN”) 10 and the Internet 20. The users of telephones 12 and 14 may be connected through the PSTN 10 via plain old telephone service (“POTS”) lines, integrated services digital network (“ISDN”) lines, frame relay (“FR”) lines, etc. A mobile phone 16 may be connected through the PSTN 10 via a base station 18. In addition, there may be a Voice over Internet Protocol (“VoIP”) portion of the network arrangement 1. Internet Protocol (“IP”) phones 22 and 24 are equipped with hardware and software allowing users to make voice phone calls over a public or private computer network. In this example, the network is the public Internet 20. The IP phones 22 and 24 have connections to the Internet 20 for the transmission of voice data for the phone calls made by the users.

Those of skill in the art will understand that the network arrangement 1 is only illustrative and is provided to give a general overview of a network which may include an automated voice service. Furthermore, those of skill in the art will understand that providing voice communications over the PSTN 10 and/or the Internet 20 requires a variety of network hardware and accompanying software to route calls through the network. Exemplary hardware may include central offices, switching stations, routers, media gateways, media gateway controllers, etc.

The automated call server 32 of the DA service 30 may include hardware and/or software to automate the phone conversation with a user. There are various types of automated phone conversations which may include voice prompts, keypad input and voice input. The exemplary embodiment of the present invention is applicable to those automated conversations which include voice input from the user and voice recognition by the automated call server 32. The automated call may also include other features. An automated phone conversation which includes voice recognition utilizes an automatic speech recognition (“ASR”) engine which analyzes the user responses to prompts to determine the meaning of the user responses. In the exemplary embodiment, the ASR engine is included in the automated call server 32. As will be understood by those of skill in the art, the exemplary embodiment of the present invention is not limited to any particular type of automated call server and can be implemented on any service which provides automated conversations without regard to the hardware and/or software used to implement the service.

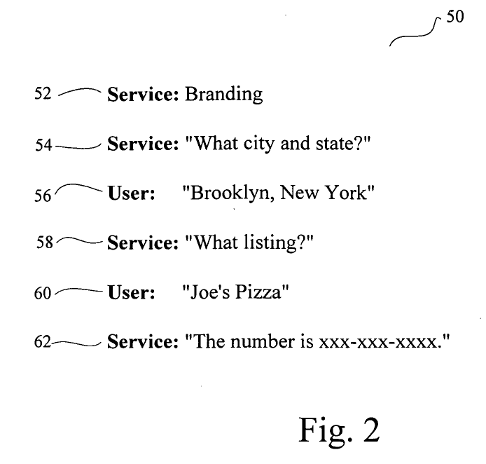

The general operation of the automated call server 32 will be described with reference to the exemplary conversation 50 illustrated by FIG. 2. The prompts provided by the service are indicated by “Service:” and the exemplary responses by the user are indicated by “User:” This exemplary conversation 50 may occur, for example, when a user dials “411 information” on the telephone 14. The user is connected through the PSTN 10 to the DA service 30. In this example, the default setting for the DA service 30 is to route incoming phone calls to the automated call server 32 so that at least an initial portion of the phone call will be automated. The goal of the DA service 30 is for the entire phone call to be automated but, as will be described in greater detail below, this is not always possible.

In the example of FIG. 2, a user is connected to the automated call server 32 which initially provides branding information for the DA service 30 as shown by line 52 of the conversation 50. The branding information may be, for example, a voice identification of the service, a distinctive sound tone, a jingle, etc, which identifies the DA service 30. The next line 54 of the conversation 50 is a voice prompt generated by the automated call server 32. In this example, the voice prompt queries the user as to the city and state of the desired listing, using the voice prompt “What city and state?”

On line 56 of the conversation 50, the user responds to the voice prompt of line 54. In this example, the user says “Brooklyn, N.Y.” and this audio data is presented to the automated call server 32. As described above, the automated call server 32 includes an ASR engine which analyzes the speech of the user to determine the meaning of the response and categorizes the response as indicating input information corresponding to the City of Brooklyn and the State of New York. For those more interested in understanding how ASR engines process and recognize human speech, they are referred to “Speech and Language Processing: An Introduction to Natural Language Processing, Computational Linguistics and Speech Recognition” by Daniel Jurafsky and James H. Martin.

The automated call server 32 then generates a further voice prompt in line 58 in response to the city/state response in line 56. The voice prompt in line 58 prompts “What listing?” On line 60 of the conversation 50, the user responds to the voice prompt of line 58. In this example, the user says “Joe's Pizza” and this audio is forwarded to the automated call server 32 for analysis. The ASR engine of the automated call server recognizes the speech as corresponding to a listing for Joe's Pizza and provides this information to the automated call server 32 which searches for the desired listing. For example, the automated call service may access a database associated with Brooklyn, N.Y. and search for the listing Joe's Pizza. When the automated call server 32 has found the listing, it generates a system response such as that shown in line 62 of the conversation 50. This system response in line 62 provides to the user the phone number of the desired listing in the form “The requested phone number is XXX-XXX-XXX. ” At this point, the user has obtained the desired information from the DA service 30 using a fully automated conversation directed by the automated call server 32 and the call ends.

However, it is not always possible and/or desirable to complete a fully automated conversation. In the example of the DA service 30, there may be a multitude of reasons why a call cannot be completed using only automation, including situations where the ASR engine does not recognize the user's speech, the user fails to provide proper responses to the system prompts, the desired listing does not exist, etc. In these situations, it may be desirable for the phone call to be re-routed from the automated call server 32 to the operator assistance 34 portion of the DA service 30 so that a live operator may interact with the user to complete the call. The operator assistance 34 portion may provide tools to the live operator to help complete the call in a more efficient fashion. For example, if the automated call server 32 determines that the user has already provided valid city and state information, this information may be transferred to the live operator to minimize the repetition of queries to the user.

As described above, the goal of the DA service 30 is to complete as many phone calls using the automated call server 32 as possible. However, this goal must be balanced with the customer satisfaction resulting from these calls. For example, if a customer notes that it takes 1 minute to complete an automated call, but it was previously only taking 30 seconds with a live operator, while the call was completely automated, the customer may not be satisfied with the experience. In another example, if a customer is required to repeat responses to the same voice prompt, the call may be completely automated, but the customer may become frustrated with the service and avoid using the service in the future. Thus, the DA service 30 must balance the desire to automate calls with customer satisfaction.

This balance may be struck by re-routing calls from the automated call server 32 to the operator assistance 34 portion before the customer becomes frustrated with the automated call. A manner of determining when this re-routing should occur according to an exemplary embodiment of the present invention is based on a quality score for the automated conversation which may, for example, be kept as a running tally during the automated portion of the phone call. When the quality score reaches a predetermined threshold value, a manner in which the call is handled is automatically changed in a predetermined way. For example, when the quality score reaches a threshold value, the call may be automatically re-routed from the automated call server 32 to the operator assistance 34 portion. The quality score relates to the occurrence of various categorized events throughout the conversation, allowing the system to look at each call as a whole, rather than taking action when any specific individual event or criteria is met. Prior systems have redirected calls based on singular events or on multiple occurrences of a singular event. However, as will be described in detail below, the exemplary embodiments of the present invention provides for the monitoring of multiple events during a conversation and the definition of unique weighting values or impacts of these events.

The following will provide examples of events which may cause the quality score to increment. Every line of conversation 50 shown in FIG. 2 may be considered an event or may even be associated with multiple events. However, not every event needs to contribute to the quality score of a particular conversation. In general, the quality score will relate to events which could cause frustration or dissatisfaction for the user. There may be neutral events which do not cause the quality score to increase. In addition, in certain situations positive events may be monitored and, when they occur, may decrement the score or may cause the total score to be reset to a new lower value. For example, if a user is successfully provided with a phone number for a first listing, the score may be reset to a new value for an additional listing request by the user. The score may be reset to the same value at which the call was initiated (e.g., zero) or to a slightly higher value determined based on the score at the completion of the first listing request.

In the example of conversation 50, the branding information and the city/state voice prompt may be considered neutral events which do not cause any increase in the quality score. Similarly, events where the user input is correctly interpreted and the conversation proceeds smoothly to the next logical step may be considered positive or neutral events which do not cause the quality score to increase. There may be embodiments of the present invention where a positive event may completely or partially counteract the effects of a negative event on the quality score. However, the preferable embodiments only tally negative events in the quality score as such a system reflects the user's expectations of a positive outcome from the service. Thus, if a user has already reached an increased level of frustration during a call, this frustration level will not generally decrease during the call when the system performs adequately.

It should be noted that throughout this description, negative events are termed to cause an increase in the quality score. For example, a negative event may be scored as +1, +3, +5, etc.

Thus, a higher quality score results in a lower quality experience for the customer, i.e., the quality score increases as the user experiences more negative events or events assigned a higher individual frustration level. The following description provides examples of exemplary quality scores for these negative events, examples of quality score thresholds and examples of the results of implementing various quality scores and thresholds. Those of skill in the art will understand that it is also possible to assign negative quality scores (e.g., −1, −2, −3, etc.) to a negative event, decrementing the quality score from a starting value (e.g., 10) to a threshold value (e.g., 0).

In the example of the conversation 50 of FIG. 2, it is highly unlikely that a customer would become frustrated because the call does not include any of the generally accepted negative events associated with automated calls. Each of the events in conversation 50 may be termed a neutral or positive event. Thus, if it is considered that each of the events are neutral or positive with a quality score of zero (0), the quality score for the conservation 50 will be zero (0), e.g., a low level of frustration for the user.

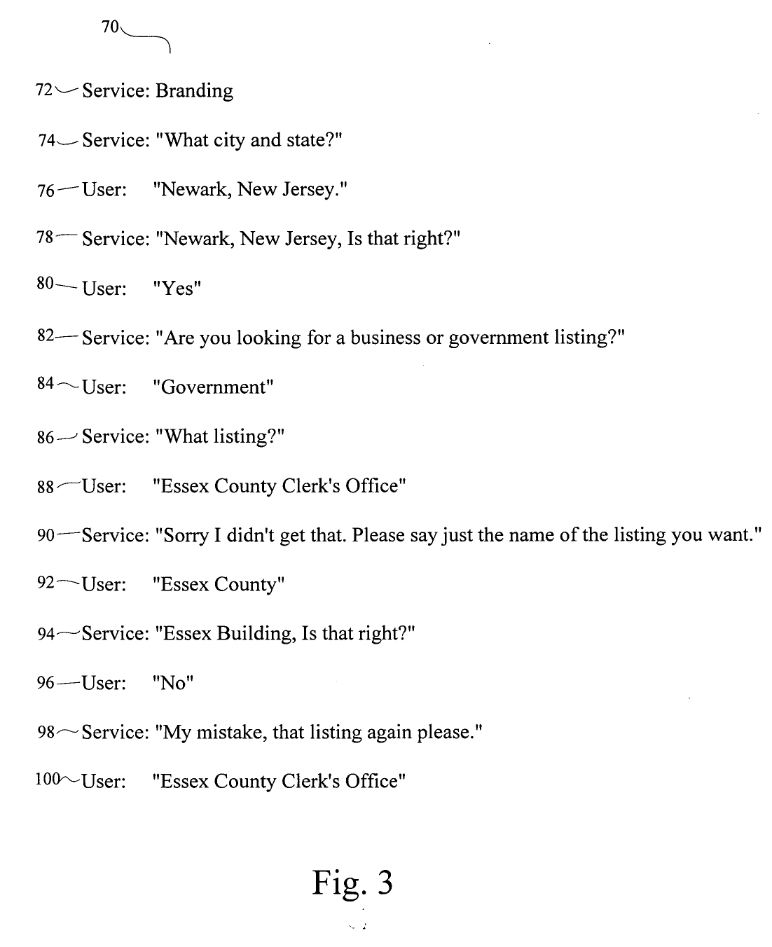

In contrast, FIG. 3 shows an exemplary conversation 70 which includes several negative events that may cause customer frustration. The conversation 70 is presented in the same format as the conversation 50 of Fig.2. The conversation 70 starts out on lines 72 and 74 with a similar branding message and voice prompt for the city and state of the listing, respectively, as described above for lines 52 and 54 of conversation 50. The user then responds to the voice prompt of line 74 with the desired city and state in line 76, i.e., “Newark, N.J.”

In conversation 70, the automated call server responds to the voice input by providing a locality confirmation prompt in line 78 in the form of “Newark, N.J., Is that right?”There may be any number of reasons for the insertion of the locality confirmation prompt in conversation 70. For example, the ASR engine here has recognized the speech of the user.

However, since users may speak differently depending on a variety of factors, the ASR engine may assign a probability value indicating a level of confidence that it has properly recognized a user response. For example, the ASR engine may assign an 85% probability that it has correctly recognized “Newark, New Jersey.” The automated call server 32 may include logic which dictates that, when the user's city and state response is recognized with a probability of less than 90% and greater than a lower probability threshold, the automated call server 32 will generate a locality confirmation prompt as shown in line 78.

The user in line 80 responds to the locality confirmation prompt of line 78 by responding that the locality information is correct (i.e., “Yes”) and the automated call server 32 generates a listing type prompt in line 82 in the form of “Are you looking for a business or government listing?” The user then responds to the listing type prompt of line 82 with the desired type of listing in line 84, i.e., “Government.” In response to the listing type response in line 84, the automated call server 32 generates another voice prompt in line 86 requesting the listing desired by the user. This prompt is in the form of “What listing?” The user then responds to the listing prompt of line 86 with the desired listing in line 88, i.e., “Essex County Clerk's Office.”

In this example conversation, the automated call server 32 is unable to successfully match the user's listing request to an entry in the database(s). Again, there may be many reasons for this mismatch. For example, it may be that the ASR engine is unable to recognize the words spoken by the user. In another example, the ASR engine may recognize the words, but the words may not be in a format recognized by the automated call server 32 or in a format which does not correspond to the listing information stored in the database(s). The user's request may also include too much or too little information to query the DA service 30 for the listing. Whatever the reason for the mismatch, the automated call server 32 generates a re-prompt to request the listing information once again. In this example, the re-prompt is shown in line 90 and is in the form of “Sorry I didn't get that, please say just the name of the listing you want.” The user then responds to the listing re-prompt of line 90 with the desired listing in line 92, i.e., “Essex County.”

The automated call server 32 then generates a listing confirmation prompt which is shown in line 94 in the form of “Essex Building, Is that correct?” As described above with respect to the locality confirmation prompt of line 78, there may be various reasons for the generation by the automated call server 32 of this listing confirmation prompt on line 94, such as a low confidence in the ASR's recognition of the user's speech. Another reason for the listing confirmation prompt may be the existence of multiple similar listings. In the example of conversation 70, the automated call server 32 did not correctly recite back the requested listing, i.e., the user stated “Essex County” and the automated call server stated “Essex Building.” Thus, the user responded to the listing confirmation prompt of line 94 with a negative response in line 96, i.e., “No.”

The automated call server 32 responds to the negative response in line 96 with another listing re-prompt as shown in line 98 in the form “My mistake, that listing again.” The user then responds to the listing re-prompt of line 98 with the desired listing in line 100, i.e., “Essex County Clerk's Office.” The conversation 70 is then stopped and re-routed to the operator assistance 34 portion because the quality score reached a threshold value beyond which the DA service 30 determined it was better to transfer the call to a live operator than to continue with an automated call. As described above, the information already collected by the automated call server 32 is preferably made available to the live operator when the call is re-routed to the operator assistance 34 portion of the DA service 30. The live operator may then complete the call for the user (not shown in FIG. 3).

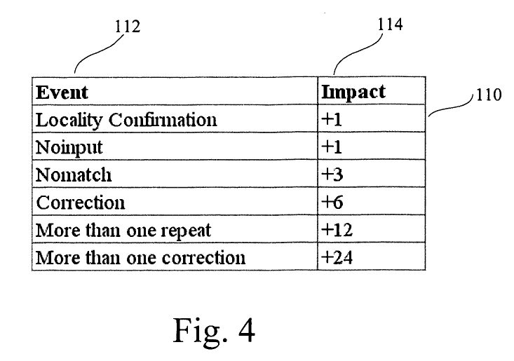

As described above, the exemplary conversation 70 illustrated by FIG. 3 includes several negative events, each of which impacted the overall satisfaction of the user. FIG. 4 shows a table 110 which includes exemplary categories for these negative events in column 112 and, in column 114, an exemplary quality score corresponding to an impact of each occurrence of an event of each column on the user's satisfaction. This table 110 will be used to demonstrate an exemplary quality score for the conversation 70 of FIG. 3. It should be noted that the events listed in table 110 are a set of events which an exemplary provider of DA service 30 considered negative events, i.e., events which increased a level of user frustration. A different provider of the exact same type of DA service 30 may consider a different set of events to be negative events for their users or may have the same listing of negative events with very different point totals for each category of event. The different set of negative events for different providers may be based on a variety of factors such as geographic location (e.g., community standards), type of customers (e.g., mobile customers vs. wired line customers), and empirical or anecdotal evidence from actual calls. Furthermore, a different type of automated conversation service (e.g., a bank providing automated voice services for transactions) may have a completely different set of negative events that impact their users.

Each individual provider of an automated conversation service may select the negative events which contribute to the quality score for automated calls in their service. The list of negative events may be expanded and/or restricted, as experience dictates, throughout the life of the service. The listing of negative events and their corresponding quality scores may be stored in the automated call server 32 so that as the negative events occur, the automated call server 32 may keep a running tally of the quality scores of conversations and may adjust the points associated with each event of the various categories and may even adjust the threshold values as well (e.g., to achieve a desired level of automation).

Returning to the conversation 70 of Fig.3, it may be considered that a conversation begins with a quality score of zero (0). The first negative event to occur in the conversation 70 (based on the negative events defined in table 110) is the locality confirmation of line 78. As shown in table 110, a locality confirmation event is defined as a negative event and is assigned a quality score impact of +1. The relative values for the quality score impact will be discussed in greater detail below. Thus, the first negative event in line 78 causes the quality score for the conversation 70 to be incremented to +1.

The second negative event to occur in conversation 70 is a Nomatch in line 90. As described above, the voice re-prompt of line 90 is precipitated by the automated call server 32 being unable to match the voice input of the user in line 88 with the desired outcome. This may be termed a nomatch negative event. As shown in table 110, a nomatch event is assigned a quality score impact of +3. Thus, after the second negative event in line 90, the quality score for the conversation is incremented by +3 to a total score of +4.

The third negative event to occur in conversation 70 is a correction as shown in lines 94 and 96. As described above, in line 94, the automated call server 32 provides a listing confirmation prompt that is incorrect as indicated by the user's negative response in line 96. This may be termed a correction negative event. As shown in table 110, a correction event is assigned a quality score impact of +6. Thus, after the third negative event in lines 94 and 96, the quality score for the conversation is incremented by +6 to a total score of +10.

The final negative event to occur in conversation 70 is a multiple repeat event (more than one repeat) as shown in line 98. The automated call server had already requested the listing twice in lines 86 and 90. The listing re-prompt in line 98 is the third instance of a listing prompt, i.e., the second repeat of the listing prompt. As shown in table 110, a more than one repeat event is assigned a quality score impact of +12. Thus, after the final negative event in line 98, the quality score for the conversation is incremented by +12 to a total score of +22.

As described above, the conversation 70 was re-routed from the automated call server 32 to a live operator of the operator assistance 34 portion to complete the call. Thus, based on this re-routing of the call, it can be extrapolated that the threshold for transferring the call was set at a quality score value of greater than +10, but less than or equal to +22. That is, when the quality score was +10 after the third negative event, the call remained with the automated call server 32. However, after the final negative event (i.e., the more than one repeat event) which incremented the quality score to +22, the call was re-routed to the operator assistance 34 portion to complete the call. The setting of the thresholds will be described in greater detail below.

The table 110 of negative events and the conversation 70 may also be used to demonstrate the provider preference selections described above. In this example, the provider of DA service 30 has decided that a locality confirmation prompt is a negative event. A second provider may decide that its customers either do not mind a locality confirmation prompt or they even prefer a locality confirmation prompt. In such a case, the second provider may not define the locality confirmation as a negative event and it may not contribute to the quality score.

In addition, the conversation 70 includes both a locality confirmation prompt (line 78) and a listing confirmation prompt (line 94). However, the provider has determined that a listing confirmation prompt is not a negative event that impacts customer satisfaction. Thus, the listing confirmation prompt is not included as a negative event in the table 110. Another provider, however, may consider a listing confirmation prompt as a negative event and include it as a negative event when calculating the quality score.

Furthermore, it should also be noted that while the listing confirmation prompt of line 94 is not a negative event because it is a listing confirmation prompt, it does form the basis of the correction negative event described above. This illustrates that a single event during a conversation may be classified as (or related to) one or more negative events that contribute to the quality score. If, for example, the provider determined that a listing confirmation prompt was a negative event and assigned a score of +1 to this type of event, then the quality score result of the listing confirmation prompt of line 94 would be both a correction event score of +6 and a listing confirmation event of +1.

There are additional events listed in table 110 which did not occur in the conversation 70. These events are the Noinput event having a quality score of +1 and a more than one correction event having a quality score of +24. A noinput event is where a user does not respond to a voice prompt. For example, when the service prompts the user for the city and state of the desired listing in line 74, the user may not respond to the prompt if, for example, the user was distracted and did not hear the prompt. After a certain time out period (e.g., 5 seconds), the automated call server 32 recognizes that the user did not make any response, i.e., a noinput event occurred. A correction event was described above with reference to lines 94 and 96 of the conversation 70. A more than one correction event is a second correction event in the same conversation.

As shown in table 110 and described above with reference to the quality score of the conversation 70, each of the events in the table is assigned a specific quality score impact, e.g., +1, +3, +6, +12, +24. The quality score for each of the events corresponds to the relative dissatisfaction associated with the negative event. In the example of events illustrated in table 110, it can be seen that a locality confirmation event has a relatively low negative impact on a user compared to a more than one repeat event (12 to 1) and a more than one correction event (24 to 1).

The quality score values may be assigned by each provider based on their experience with the level of customer dissatisfaction associated with various events, e.g., using empirical data gathered from customer surveys. For example, a certain provider may determine that its customers have a high tolerance for a first correction event. This provider may set the quality score for a first correction event at a relatively low value. If another provider determines that its customers have a very low tolerance for any correction events, it will set the quality score for a first correction event at a relatively high value. Similar to the actual events which are qualified as negative events, the quality scores of these negative events may be changed at any time as a provider gains more data or evidence as to the relative customer dissatisfaction associated with particular events.

The negative events and the quality score may also be more refined to be more granular than a single service provider. For example, a service provider operating DA service 30 may cover an entire state which is made up of multiple counties, multiple area codes, etc. The service provider may collect data that indicates different tolerances for different events based on customer location or area code. In such a case, the service provider may have different negative events and/or quality scores for different customers that it services. This granularity may be accomplished by the automated call server 32 recording customer ANI information and employing individual settings for various classes of ANIs.

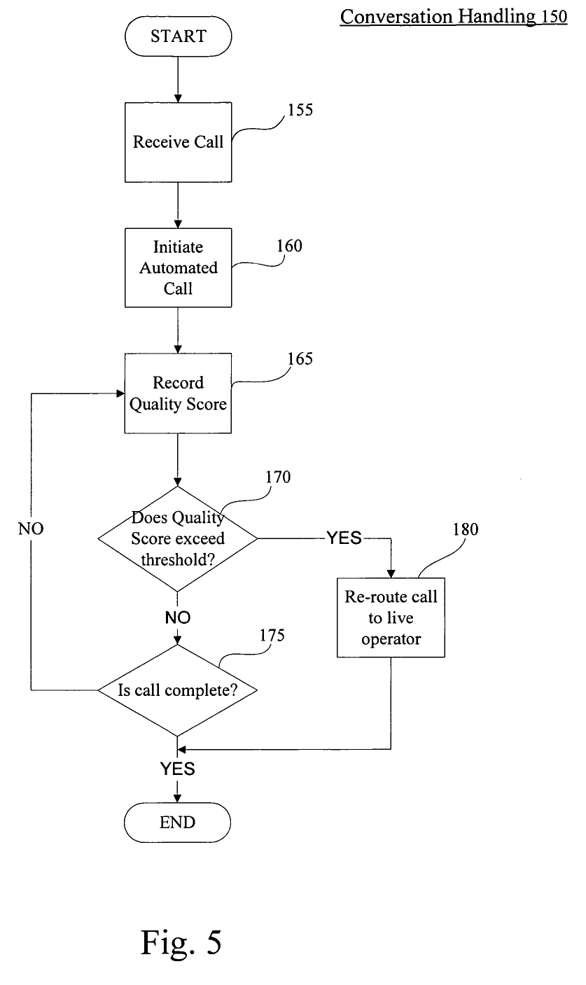

As described previously, one of the purposes of keeping the quality score is to determine when a call should be re-routed from the automated call server 32 to the operator assistance 34 portion of the DA service 30. The preceding description has illustrated examples of automated conversations, events which could adversely effect customer satisfaction and an exemplary method for determining a quality score of a conversation. FIG. 5 illustrates an exemplary method 150 for handling a conversation using the determined quality score. Again, this method will be described with reference to a phone call received by the DA service 30. However, those of skill in the art will understand that the exemplary method may be applied to any automated conversation.

In step 155, the DA service 30 receives a phone call from the user, e.g., a user of mobile phone 16 initiates a call to directory assistance. The phone call is routed to the automated call server 32 to initiate an automated conversation with the user (step 160). As the automated call progresses, the automated call server 32 records the quality score for the automated conversation. The examples provided above illustrate methods for determining a quality score for the conversation, e.g., every defined negative event increases the quality score for the conversation by a defined impact of the negative event. Thus, in step 165, a running quality score is recorded for the conversation.

In step 170, it is determined whether the current quality score for the conversation has exceeded a predetermined threshold. The predetermined threshold is a quality score value which corresponds to an unacceptable level of user frustration or dissatisfaction with the automated call. The provider of DA service 30 may determine this threshold value for the service based on a variety of factors as will be described in greater detail below.

If the current quality setting exceeds the predetermined value, the method 150 continues to step 180 where the call is re-routed to a live operator in the operator assistance 34 portion of the DA service 30. Those skilled in the art will understand that, although all of the examples describe routing the call to an operator when the predetermined threshold level is reached, that this is simply one example of a change in the handling of the call that may be made to address the user frustration/dissatisfaction. When the call has been re-routed, the automated portion of the phone call is complete and the live operator will complete the call for the user. As described above, the provider of the DA service 30 desires to automate as many calls as possible, without sacrificing customer satisfaction. Thus, the provider will set the quality score threshold at a level beyond which customer satisfaction is unacceptably low so that action can be taken to address the customer's needs (e.g., by transferring calls to the live operator) before satisfaction drops below this level. The provider may, for example, determine the threshold value by reviewing simulations of multiple phone calls and the corresponding quality scores for these simulated calls.

If the current quality score does not exceed the predetermined value in step 170, the method continues to step 175 to determine whether the call is complete. If the call is not complete, e.g., additional events need to occur to complete the call, the method loops back to step 165 and continues to record the quality score as additional conversation events occur. As described above, there are multiple conversation events for every conversation. However, not every conversation event contributes to the quality score. Some events may be defined as neutral or positive and these will not contribute to the quality score if it has been determined that only negative events will contribute to the quality score.

Thus, the method 150 continues to loop through the events of the call until either the quality score exceeds the predetermined threshold and the call is transferred to a live operator (step 180) or the automated call is successfully completed, e.g., upon receipt of a positive response to step 175. When either of these events occur, the method 150 is complete.

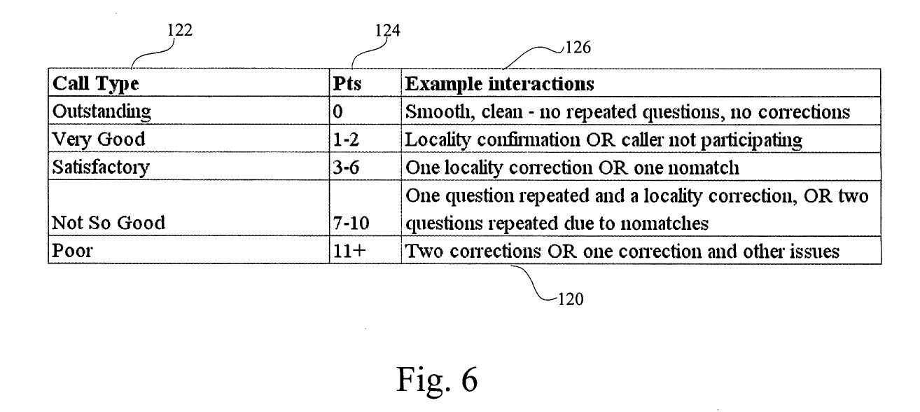

FIG. 6 shows a table 120 which categorizes calls based on the quality score of the call.

The first column 122 shows the call category into which a particular call falls and the second column 124 shows the quality score range for each of the categories. In this example, there are five categories: Outstanding-0 points; Very Good-1-2 points; Satisfactory-3-6 points; Not So Good-7-10 points; and Poor -11+ points. The third column 126 shows the types of events which may occur (based on the events and quality scores of table 110 of FIG. 4) to generate the scores associated with each category. These categories may be used to determine the effectiveness of the quality score index and to set the predetermined threshold for call transfers.

For example, a provider using the categories described by table 120 may determine that as soon as an automated call is no longer in the Outstanding or Very Good category, the call should be transferred from the automated call server 32 to the operator assistance 34 portion. Based on the categories presented in table 120, the provider would set the predetermined threshold quality score at +2. Thus, in step 170 of the method 150 described in FIG. 5, when the quality score of any call exceeds +2, the call is transferred to the live operator (step 180). Another provider may determine that their customers are satisfied with automated calls as long as they are in the category Satisfactory or better. Thus, this provider may set the predetermined threshold quality score to +6 according to the values given in table 120.

Those of skill in the art will understand that the categories and quality score ranges provided by table 120 are only exemplary. For example, a provider may determine that only two categories are required, Satisfactory and Unsatisfactory. In addition, a provider may determine different ranges such as an Outstanding call having a range of 0-2 quality score. There is no need to define call categories, it is merely used to gauge relative customer satisfaction compared to the quality score for a conversation.

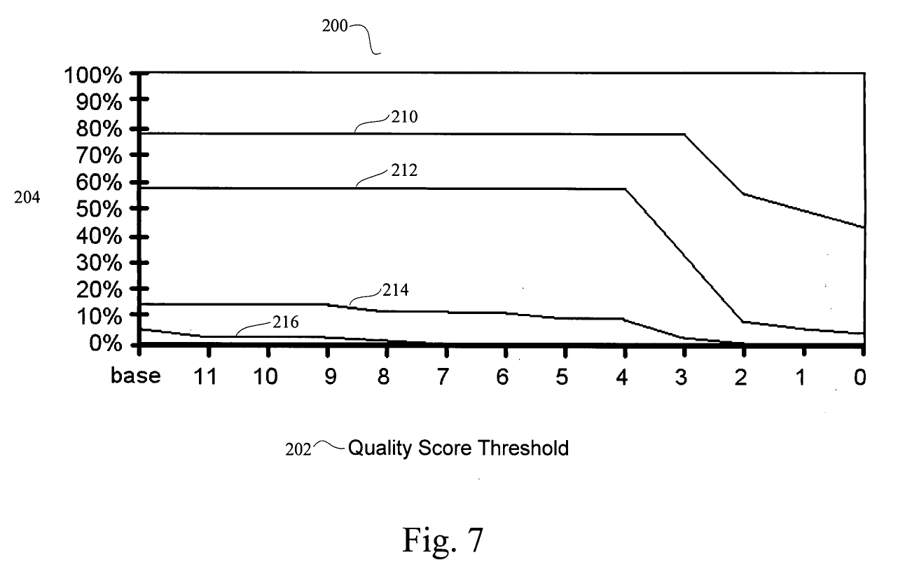

FIG. 7 shows a graph 200 with exemplary results for various quality score threshold values. The horizontal axis of the graph 200 shows various settings for the quality score threshold 202 from 0-11. The vertical axis of the graph 200 shows a percentage 204 of calls which fall into the various call categories based on the threshold setting. The categories, which are the same as those described with reference to FIG. 6, are shown on the graph as follows: calls above line 210 are Outstanding; calls between lines 212 and 210 are Very Good; calls between lines 212 and 214 are Satisfactory; calls between lines 214 and 216 are Not So Good; and calls below line 216 are Poor.

Thus, as can be seen from the graph, with a quality score threshold set at +11, approximately 4% of the calls are Poor, 10% are Not So Good, 45% are Satisfactory, 20% are Very Good and 21% are Outstanding. As the quality score threshold is decreased, customer satisfaction is increased. As can be seen in graph 200, the Poor calls are eliminated when the quality score index is set to +7. Similarly, it can be seen in this example that there is a significant increase in the quality rating of automated calls when the quality score threshold is set to +2.

Those of skill in the art will understand that the results illustrated in FIG. 7 are only exemplary. A service provider may derive a different chart in order to determine the efficacy of the quality score threshold based on, for example, actual quality scores from user's calls and/or data from user's surveys, etc. The service provider may then use this information to set the quality score threshold at a value which accomplishes the specific goals for automation level and customer satisfaction.

In addition, as with the negative event definitions and the relative impact of these definitions, the threshold may also be set with a certain amount of granularity. This granularity may include different thresholds for different types of users (e.g., wired line users, mobile phone users, user's locations, business users, residential users, etc.) and/or different thresholds for different call states.

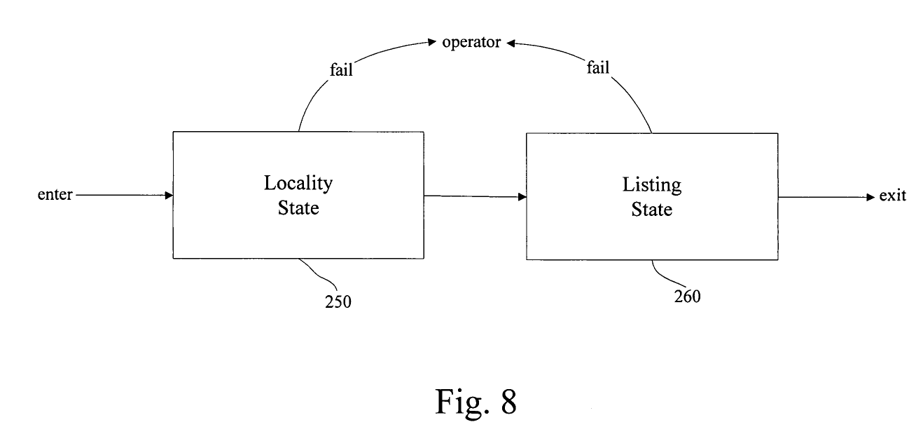

FIG. 8 shows an exemplary state diagram for an automated conversation. Those of skill in the art will understand that the state diagram in FIG. 8 is a simplified state diagram. An automated conversation may have any number of states and/or sub-states. The state diagram has a locality state 250 and a listing state 260. Referring to the conversation 50 of FIG. 2, it may be considered that when the service prompts the user for the city and state in line 54 and the user replies in line 56 that the conversation 50 is in the locality state 250. Once the user has successfully completed the locality state, i.e., the automated call server 32 has successfully recognized the city and state of the listing, the conversation 50 moves into the listing state 260 as shown by lines 58 through 62 in which the user is prompted for the listing, communicates to the system the desired listing and receives the listing. However, as shown in the state diagram, if there is a failure (e.g., the quality score threshold is exceeded) while in either of the states 250 and 260, the conversation may be transferred to the live operator to complete the call.

The purpose of showing this state diagram is to illustrate that the quality score threshold may be set with granularity within these call states. For example, the quality score threshold may be a first value while the caller is in the locality state 250 with the quality score threshold being set to a second value when the call progresses to the listing state 260. Thus, the quality score threshold may be changed within a single conversation. Moreover, the quality score threshold may be turned off during a call. For example, if the conversation is at a point where it is very close to being completed automatically, customer frustration may be increased by transferring the call to a live operator before completion of the automated call. Thus, it may be defined that, after the conversation has entered a particular state, the quality score threshold is turned off so that the call must be completed in the automation mode.

In the above description, the quality score has been described with reference to transferring a call from an automated system to a live operator. However, the quality score may be used to control other type of conversation handling. For example, if the automated call server 32 determines that the quality score is high, but it is attributable to a specific cause such as the ASR engine having trouble recognizing the speech of the user, the high quality score may be used to change the speech recognition parameters of the ASR engine. This example demonstrates that the total quality score may also be combined with an intelligence about the type of negative event causing a high score. This combination of quality scores and event recognition may then be used to take corrective action in the automated call server 32 without transferring the call to the live operator, thereby moving the DA service 30 closer to the goal of automating all calls.

Moreover, as shown in FIG. 7, in the above example of call categorization, a service provider may use the quality score solely to obtain information with respect to customer satisfaction with the automated call system. The provider is not required to set a threshold to a value which will cause any change in the handling of the calls. For example, a provider may initially set up the automated call server with a message that informs a user that they will complete all calls automatically, unless the user wants to switch to a live operator by pressing “0.” The provider may then collect data and determine the quality score by determining when user frustration rises to a level where they press “0.” In this case, although no threshold is set, the provider collects valuable information indexed to the quality score which may allow the provider to accurately set a threshold at a later time.

Throughout this description, the automated call server 32 has been described as providing and/performing a variety of functions related to the automation of conversations. Those of skill in the art will understand that these functions described for the automated call server 32 may be performed by multiple hardware devices, e.g., server computers located in a multitude of locations, and multiple software applications or modules. The automated call server 32 should not be considered to be a single hardware device and/or software application. In one exemplary embodiment, the software code used to implement the above described quality score embodiments is written in Voice Extended Markup Language (“VoiceXML”). VoiceXML is an application of the Extensible Markup Language (XML) which, when combined with voice recognition technology, enables functionality associated with automated conversations.

The above exemplary embodiments each described examples of a quality score being assigned to events or categories of events and the total quality score being recorded for the purpose of initiating a conversations handling action when the total quality score exceeds a predetermined threshold. In a further embodiment, a score is not assigned to the events or categories of events, but rather the events themselves are recorded. The system may include a listing of events (and the order of these events) for which a conversation handling action should be initiated. For example, the system may have a stored series of events such as Locality Confirmation-Noinput-Nomatch. If the system records these events in this order, the system may then initiate a conversation handling action (e.g., transfer to a live operator). In this manner, the conversation handling action is initiated based on the events, but it is not relying on a numerical quality score.

The present invention has been described with the reference to the above exemplary embodiments. One skilled in the art would understand that the present invention may also be successfully implemented if modified. Accordingly, various modifications and changes may be made to the embodiments without departing from the broadest spirit and scope of the present invention as set forth in the claims that follow. The specification and drawings, accordingly, should be regarded in an illustrative rather than restrictive sense.

What is claimed is:

1. A method, comprising:
categorizing a plurality of events which occur during automated conversations based on an impact of the events on a level of user satisfaction with the automated conversations;
assigning to each category of events a quality score corresponding to the impact on user satisfaction of the events in each category; and
initiating a conversation handling action for one of the conversations based on the categories of events detected during the one of the conversations.

2. The method of claim 1, wherein detecting the categories of events includes the steps of:
identifying categorized events occurring in the one of the conversations; and
incrementing a total quality score by a value corresponding to the quality score for each identified event.

3. The method of claim 2, wherein the conversation handling action is initiated at a total quality score threshold.

4. The method of claim 1, wherein the automated conversations are automated phone calls.

5. The method of claim 4, wherein the conversation handling action is transferring the one of the phone calls to a live operator.

6. The method of claim 1, wherein the events include one of a confirmation event, a no input event, a no match event, a correction event and a more than one repeat event.

7. The method of claim 1, further comprising:
resetting the total quality score prior to initiating a conversation handling action.

8. The method of claim 7, wherein the resetting is in response to the occurrence of an event categorized as having a positive impact on user satisfaction with the automated conversations.

9. The method of claim 1, wherein the quality scores assigned to the various categories of events is based on a characteristic of the user.

10. The method of claim 9, wherein the characteristic includes a location of the user.

11. The method of claim 1, wherein the quality score corresponding to a category of events is based on a characteristic of the user.

12. The method of claim 1, wherein the initiating step is suspended for the one of the conversations when the one of the conversations reaches a predefined state.

13. A system, comprising:
a storage module storing a categorization of a plurality of events which occur during automated conversations, the categorization being based on an impact of the events on a level of user satisfaction with the automated conversations, wherein each of the events of each category is assigned a quality score corresponding to the impact on user satisfaction of the events in each category; and
a quality score module initiating a conversation handling action for one of the conversations based on the categories of events detected during the one of the conversations.

14. The system of claim 13, wherein the quality score module records a total quality score for the one of the conversations by identifying categorized events occurring in the one of the conversations and incrementing the total quality score by a value corresponding to the quality score for each identified event.

15. The system of claim 13, further comprising:
a conversation handling module implementing the conversation handling action when initiated by the quality score module.

16. The system of claim 13, further comprising:
an automated prompting module providing prompts to a user during the automated conversation.

17. The system of claim 16, further comprising:
an automatic speech recognition engine analyzing user responses to the prompts to identify information included in the responses.

18. The system of claim 13, wherein the conversation handling action is transferring the one of the automated conversations to a non-automated conversation handler.

19. The system of claim 17, wherein the conversation handling action is a change of a parameter of the automatic speech recognition engine.

20. The system of claim 14, wherein the conversation handling action is initiated when a total quality score threshold is reached.

21. The system of claim 20, wherein the total quality score threshold is set based on desired performance characteristics of the system to achieve a desired minimum level of customer satisfaction.

22. The system of claim 13, wherein the quality score module is implemented using Voice XML.

23. A system comprising a memory to store a set of instructions and a processor to execute the set of instructions, the set of instructions being operable to:
access a categorization of a plurality of events which occur during automated conversations, the categorization being based on an impact of the events on a level of user satisfaction with the automated conversations;
access a quality score assigned to each category of events, the quality score corresponding to the impact on user satisfaction of the events in each category; and
initiate a conversation handling action for one of the conversations based on the categories of events detected during the one of the conversations.

24. A method, comprising:
categorizing a plurality of events which occur during automated conversations based on an impact of the events on a level of user satisfaction with the automated conversations;
assigning to each category of events a quality score corresponding to the impact on user satisfaction of the events in each category; and
recording user satisfaction for a plurality of automated conversations based on the categorization of events detected during the conversations.

25. A method, comprising:
storing a sequence of events which occur during automated conversations;
recording events in one of the automated conversations;
initiating a conversation handling action for the one of the conversations when the recorded events correspond to the stored sequence of events.
